(19) United States
(12) Patent Application Publication
(10) Pub. No.: US 2006/0277807 A1
(43) Pub. Date: Dec. 14, 2006

(54) Method and apparatus for forming a laminate panel with improved fire worthiness

(75) Inventors: J. Christopher Wilde, Mill Creek, WA (US); John N. Harris, Seattle, WA (US); Brian J. Wimer, Bothell, WA (US); J. Thomas Stoner, Renton, WA (US); Kris E. Langkow, Snohomish, WA (US)

Correspondence Address: HARNESS, DICKEY & PIERCE, P.L.C., P.O. BOX 828, BLOOMFIELD HILLS, MI, 48303, US

(73) Assignee: The Boeing Company

(21) Appl. No.: 11/446,784

(22) Filed: Jun. 5, 2006

Related U.S. Application Data
(60) Provisional application No. 60/688,414, filed on Jun. 8, 2005.

(51) Int. Cl. G09F 15/00; B32B 3/00

(52) U.S. Cl. 40/606.07; 428/204

(57) ABSTRACT

A laminate panel is provided for forming an aesthetically pleasing fire worthy exterior surface on an object; for example, a decorative interior panel used in a commercial aircraft. A first film layer forms an exterior surface of the panel, and an embossing resin layer is disposed adjacent to the first film layer. A second film layer is disposed adjacent to the embossing resin layer. The second film layer is impregnated with at least one heat sink material to enhance the fire worthiness of the laminate panel by operating to absorb thermal energy released by the panel in the event the panel is exposed to fire or to a high temperature sufficient to otherwise cause combustion of a conventional laminate panel. Accordingly, the laminate panels serve to provide an aesthetically pleasing surface on the associated object and also act as a mechanism to increase the fire worthiness of the associated object.

### CROSS-REFERENCE TO RELATED APPLICATIONS

This application claims the benefit of U.S. Provisional Application No. 60/688,414, filed on Jun. 8, 2005, which is related in general subject matter to pending U.S. patent application Ser. No. 10/882,047, filed Jun. 30, 2004, assigned to The Boeing Company, and hereby incorporated by reference into the present application. Additionally, the subject matter of the present application is related to U.S. Provisional Application No. 60/688,414, filed concurrently with the provisional of this application on Jun. 8, 2005 (now U.S. patent application Ser. No. 11/194,498, filed Aug. 1, 2005), also assigned to The Boeing Company, the disclosure of which is also hereby incorporated by reference into the present application.

### FIELD

The present disclosure relates to laminate panels, and more particularly to a system and method for forming laminate panels with improved fire worthiness.

### BACKGROUND

Certain mobile platforms, such as aircraft, trains and automobiles, generally employ laminate panel structures to form various surfaces. Laminate panel structures serve to provide visually appealing surfaces to the objective viewer. For example, in a commercial aircraft, a plurality of laterally aligned overhead stowage bin doors is typically included along the port and starboard sides of the passenger cabin of the aircraft. These stowage bin doors each generally include a laminate panel disposed on the front of the stowage bin door to create a visually appealing interface for the customer. In addition, many other surfaces can be coated with a laminate panel to increase the visual appeal of the surface, such as doors, ceiling tiles and the like. Further, in some instances, laminate panels can also be used to display information to potential viewers, such as safety hazards or use instructions.

As many mobile platforms are subject to fire worthiness standards, it would be advantageous if the laminate panels could absorb thermal energy in the event of a fire. Such laminate panels could be affixed to any desired structure to reduce the amount of thermal energy released by the desired structure during a combustion event. Thus, the laminate panels increase the fire worthiness of the desired structure while providing an aesthetically pleasing surface.

### SUMMARY

The present disclosure is directed to a laminate panel for forming an aesthetically pleasing, fire worthy exterior surface on an object. A first film layer forms an exterior surface of the object, and an embossing resin layer is disposed adjacent the first film layer. A second film layer is disposed adjacent the embossing resin layer. At least one of the embossing resin layer and second film layer is impregnated with a heat sink material to provide a fire worthy laminate panel.

The present disclosure also includes providing a laminate panel adapted for use in connection with a plurality of functional panels on a mobile platform for displaying an image. The laminate panel comprises a first film layer that forms an exterior surface of the panels and an ink layer forming at least a portion of the image. The ink layer is disposed adjacent the first film layer. An embossing resin layer is disposed adjacent the ink layer, and a second film layer is disposed adjacent the embossing resin layer. At least one of the embossing resin layer and second film layer is impregnated with a heat sink material to provide a fire worthy laminate panel. The laminate panel also has an aesthetically pleasing appearance and is ideally suited for interior use in various types of mobile platforms and especially in commercial aircraft.

In addition, also provided is a laminate panel adapted for use in connection with a plurality of functional panels on a mobile platform for displaying an image. The laminate panel comprises a first film layer that forms an exterior surface of the panels and an ink layer forming at least a portion of the image. The ink layer is disposed adjacent the first film layer. A second film layer is disposed adjacent the ink layer, and a third film layer is disposed adjacent the second film layer and an exterior surface of the functional panels. The second film layer and third film layer are impregnated with a heat sink material to provide a fire worthy laminate panel. The laminate panel also has an aesthetically pleasing appearance and is ideally suited for interior use on various surfaces of mobile platforms and especially in commercial aircraft.

### BRIEF DESCRIPTION OF THE DRAWINGS

The present disclosure will become more fully understood from the detailed description and the accompanying drawings, wherein:

FIG. 1 is a simplified perspective view of a portion of an interior passenger cabin area of a commercial aircraft illustrating a laminate panel disposed on a plurality of overhead stowage bin doors, in accordance with the present disclosure;

FIG. 2 is a perspective, enlarged view of one of the stowage bin doors shown in FIG. 1;

FIG. 3 is a side, cross sectional view of the stowage bin door of FIG. 2 taken in accordance with section line 3-3 in FIG. 2 showing the various layers of a fixed laminate panel secured to the bin door;

FIG. 4 is a side, cross sectional view of the stowage bin door of FIG. 2 taken in accordance with section line 3-3 in FIG. 2 having secured thereto a strippable laminate layer according to various embodiments;

FIG. 5 is a side, cross sectional view of the stowage bin door of FIG. 2 taken in accordance with section line 3-3 in FIG. 2 showing the various layers of the fixed laminate panel of FIG. 3 according to an alternative composition;

FIG. 6 is a side, cross sectional view of the stowage bin door of FIG. 2 taken in accordance with section line 3-3 in FIG. 2 showing the various layers of the fixed laminate panel of FIG. 5 according to a second alternative composition;

FIG. 7 is a side, cross sectional view of the stowage bin door of FIG. 2 taken in accordance with section line 3-3 in FIG. 2 showing the various layers of the fixed laminate panel of FIG. 5 according to a third alternative composition;

FIG. 7a is a side, cross sectional view of the stowage bin door of FIG. 2 taken in accordance with section line 3-3 in FIG. 2 showing the various layers of the fixed laminate panel of FIG. 5 according to a fourth alternative composition;

FIG. 8 is a side, cross sectional view of the stowage bin door of FIG. 2 taken in accordance with section line 3-3 in FIG. 2 showing the various layers of the fixed laminate panel of FIG. 3 according to a fifth alternative composition;

FIG. 9 is a side, cross sectional view of the stowage bin door of FIG. 2 taken in accordance with section line 3-3 in FIG. 2 showing a sixth alternate composition of the various layers of the fixed laminate panel of FIG. 3 according to various embodiments;

FIG. 10 is a side, cross sectional view of the stowage bin door of FIG. 2 taken in accordance with section line 3-3 in FIG. 2 showing a seventh alternate composition of the various layers of the fixed laminate panel of FIG. 3 according to various embodiments;

FIG. 11 is a side, cross sectional view of the stowage bin door of FIG. 2 taken in accordance with section line 3-3 in FIG. 2 showing an eighth alternate composition of the various layers of the fixed laminate panel of FIG. 3 according to various embodiments;

FIG. 12 is a side, cross sectional view of the stowage bin door of FIG. 2, taken in accordance with section line 3-3, illustrating the strippable laminate panel of FIG. 4 in accordance with one of the various embodiments of the present disclosure;

FIG. 13 is a side, cross sectional view of the stowage bin door of FIG. 2, taken in accordance with section line 3-3, illustrating the various layers of the strippable laminate panel of FIG. 4 in accordance with a second alternative composition;

FIG. 14 is a side, cross sectional view of the stowage bin door of FIG. 2, taken in accordance with section line 3-3, illustrating the various layers of the strippable laminate panel of FIG. 4 in accordance with a third alternative composition;

FIG. 14a is a side, cross sectional view of the stowage bin door of FIG. 2, taken in accordance with section line 3-3, illustrating the various layers of the strippable laminate panel of FIG. 4 in accordance with a fourth alternative composition;

FIG. 15 is a side, cross sectional view of the stowage bin door of FIG. 2, taken in accordance with section line 3-3, illustrating the various layers of the strippable laminate panel of FIG. 4 in accordance with a fifth alternative composition;

FIG. 16 is a side, cross sectional view of the stowage bin door of FIG. 2, taken in accordance with section line 3-3, illustrating the various layers of the strippable laminate panel of FIG. 4 in accordance with a sixth alternative composition;

FIG. 17 is a side, cross sectional view of the stowage bin door of FIG. 2, taken in accordance with section line 3-3, illustrating the various layers of the strippable laminate panel of FIG. 4 in accordance with a seventh alternative composition;

FIG. 18 is a side, cross sectional view of the stowage bin door of FIG. 2, taken in accordance with section line 3-3, illustrating the various layers of the strippable laminate panel of FIG. 4 in accordance with an eighth alternative composition;

FIG. 19 is a side, cross sectional view of the stowage bin door of FIG. 2, taken in accordance with section line 3-3, illustrating the various layers of the laminate panel of FIG. 3 in accordance with an alternate construction; and

FIG. 20 is a side, cross sectional view of the stowage bin door of FIG. 2, taken in accordance with section line 3-3, illustrating the various layers of the strippable laminate panel of FIG. 4 in accordance with an alternative construction.

### DETAILED DESCRIPTION

The following description is merely exemplary in nature and is not intended to limit the present disclosure, application, or uses. It should be understood that throughout the drawings, corresponding reference numerals indicate like or corresponding parts and features.

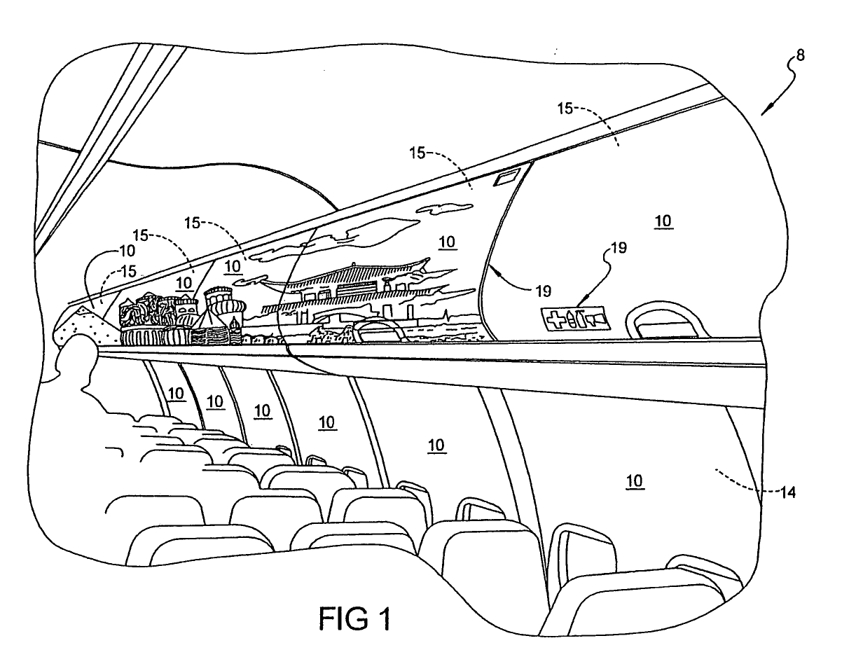

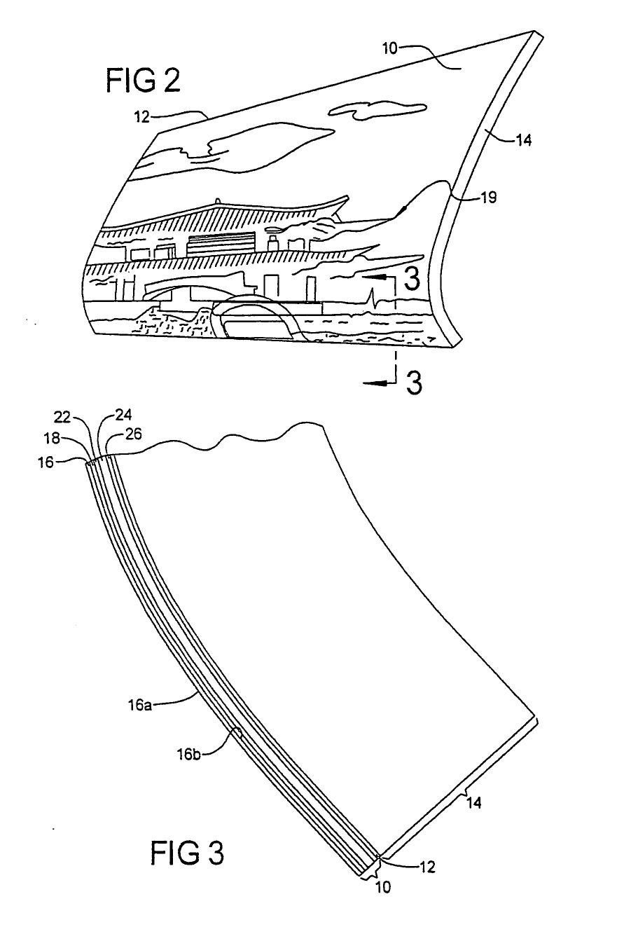

Referring to FIGS. 1 and 2, there is shown a laminate panel 10. The laminate panel 10 is coupled to a surface 12 of a stowage bin door 14 on a mobile platform 8 to form an exterior surface 15; however, the laminate panel 10 can be applied to any surface desiring an aesthetically pleasing surface. It will be appreciated that laminate panel 10 could be used to help form a variety of structural or decorative panels able to be used in a mobile platform, such as a train, automobile or aircraft, or even in a fixed (i.e., non-mobile) structure.

With reference now to FIG. 3, laminate panel 10 is comprised of a first film layer 16 having a texture on its outer surface 16a. The first film layer 16 comprises a very thin polyvinyl fluoride film, such as Tedlar® PVF film, having a thickness of about one mil. The first film layer 16 is also a clear gloss or a semi-gloss layer, but in either event it is substantially translucent or clear. Adjacent to the first film layer 16 can be an ink layer 18.

Ink layer 18 represents the ink that comprises an image 19; however, it will be understood that the laminate panel 10 could be formed without the ink layer 18 if so desired. The ink layer 18 is formed on an inside surface 16b of the first film layer 16. This eliminates the need to place a protective, separate layer over the ink layer 18, since the first film layer 16, itself, forms a protective covering for the ink on its inside surface 16b.

If the ink layer 18 is desired, the ink layer 18 should be deposited by a suitable printer, such as a digital ink jet printer, directly on the first film layer 16. Since the ink layer 18 is deposited on the inside surface 16b, it will be appreciated that the image 19 will need to be transposed during the printing process so that it appears correct when being viewed from the opposite side (i.e., outer surface 16a) of first film layer 16. Alternatively, the ink layer 18 could be formed on a second film layer 22 adjacent to the first film layer 16, as will be described in greater detail herein, which would also eliminate the need to transpose the image 19 during the printing process.

The ink used to form ink layer 18, which makes up the image 19, comprises an ultraviolet (UV) curable and stable ink (black or colored) that is deposited directly on the first film layer 16. The ink is cured virtually immediately after being deposited by the ink jet printer via a UV light operably associated with the digital ink jet printer that passes over the newly deposited ink just after the ink is deposited. Companies making suitable ink jet printers or printing equipment are Vutek of Meredith, N.H. and 3M Corp. of Maplewood, Minn. Other suitable inks are available from Sericol, Inc. of Kansas City, Kans. and Sunjet of Bath, England. The color image formed by the image 19, in one form, comprises a high contrast color image that is highly aesthetically pleasing to view. The use of UV curable ink allows the ink to be deposited directly on the first film layer 16 (or even on the second film layer 22) without the need for some type of receptive coating to be placed over the first film layer 16 or the second film layer 22, which would be necessary with water or solvent based digital ink jet inks. The ability of the UV curable ink to be cured virtually immediately after being deposited on the first and second film layers 16, 22 also simplifies and expedites the manufacturing of the laminate panel 10. In addition, UV curable inks allow ink loadings on the Tedlar® PVF in excess of 300%, which is difficult, or impossible, to obtain using water or solvent based digital ink jet inks.

The second film layer 22 is disposed against the inside surface 16b of the first film layer 16. The second film layer 22 also comprises a very thin polyvinyl fluoride film, such as a Tedlar® PVF film, that is white in color to form a suitable background against which the colors of the ink layer 18 stand out. However, it will be appreciated that other colors could be employed depending on the color scheme used in the image 19. Advantageously, the first and second film layers 16, 22 form a fire worthy material that meets Federal Aviation Administration fire safety requirements for materials used on commercial aircraft.

The laminate panel 10 further includes a layer 24 comprised of an embossing resin and a third film layer 26 that is disposed against the surface 12. The layer of embossing resin 24 can vary significantly, but in one form comprises an areal weight of 0.023 pounds/square foot (lb/ft²) to 0.031 lb/ft². The third film layer 26 comprises a very thin polyvinyl fluoride film, such as Tedlar® PVF film, having a thickness of around two mils. Third film layer 26 is generally white in color.

Once the ink layer 18, if desired, is applied to the first film layer 16 or the second film layer 22 with a suitable printer, the remaining layers of the laminate panel 10 can be arranged in a conventional multi-opening press. Generally, the laminate panel 10 is formed in a conventional multi-opening press that uses heat and pressure to laminate the individual layers making up laminate panel 10 together as a single, decorative, textured laminate structure. The textured outer surface 16a of the first film layer 16 is maintained by the embossing resin of layer 24 as the resin cures in the multi-opening press during manufacture. An infrared (IR) oven is then used to form the laminate panel 10 to the surface 12.

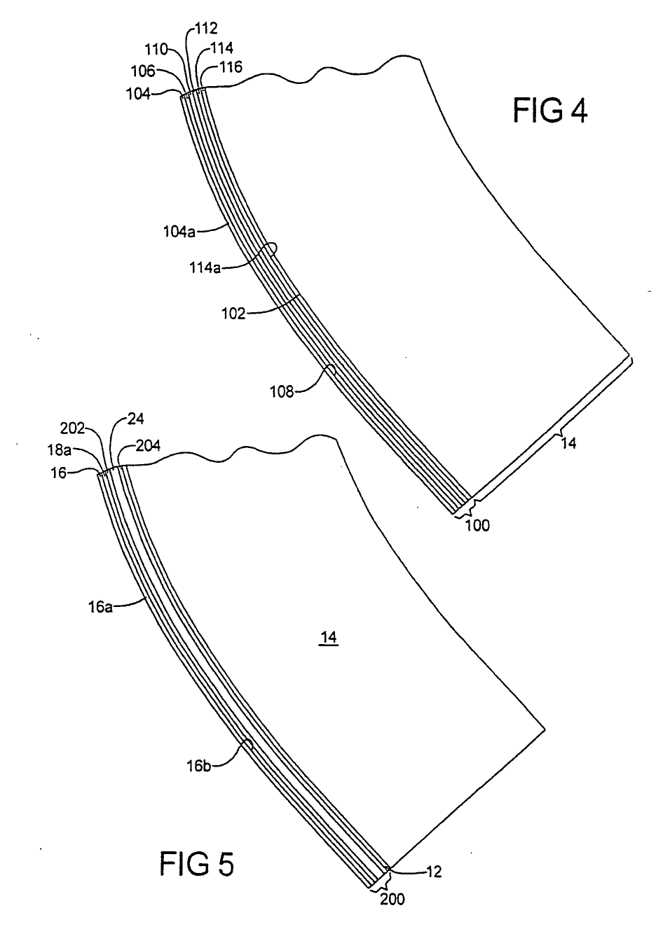

Referring to FIG. 4, there is shown an alternative form of implementation of the laminate panel 10 of the present disclosure that makes use of a strippable laminate panel secured to an associated bin door 14. One such strippable laminate panel is designated by reference numeral 100, and the desired application surface 102. With this embodiment the image 19, if included, is changed simply by removing the surface 102 from mobile platform 8 and removing each of the strippable laminate panels 100 from their respective surfaces 102, and then applying a new strippable laminate panel having a different image. Furthermore, the strippable laminate panels 100 could also be removed, and new strippable laminate panels applied to the surfaces 102, without removing the surfaces 102 from the mobile platform 8.

With reference to FIG. 4, the laminate panel 100 is similar in construction to laminate panel 10. Laminate panel 100 includes a first film layer 104 having a texture on its outer surface 104a. The first film layer 104 comprises a very thin polyvinyl fluoride film, such as Tedlar® PVF film, having a thickness of about one mil. The first film layer 104 is also a clear gloss or a semi-gloss layer, but in either event it is substantially translucent or clear. Ink layer 106 represents the ink layer that comprises the image 19. The ink layer 106 is formed on an inside surface 108 of the first film layer 104, and thus there is no need to place a protective, separate layer over the first film layer 104. The inside surface 108 of the first film layer 104 typically has a very thin adhesive layer left after the backing of the first film layer 104 is removed (not specifically shown), and the ink layer 106, if included, is generally deposited on this adhesive. As with laminate panel 10, the ink layer 106, if desired, is deposited by a suitable printer, such as a digital ink jet printer, directly on the first film layer 104, as discussed previously herein. The ink used to form ink layer 106, which makes up the image 19, generally comprises an ultraviolet (UV) curable and stable ink (black or colored).

A second film layer 110 is disposed against the inside surface 108 of the first film layer 104. The second film layer 110 also comprises a very thin polyvinyl fluoride film, such as Tedlar® PVF film, that is colored to form a suitable background against which the colors of the ink layer 106 stand out. It should be noted that, alternatively, the ink layer 106 could be formed on the second film layer 110.

The decorative textured laminate panel 100 further includes an embossing resin layer 112, a third film layer 114 disposed against the embossing resin layer 112, and an adhesive layer 116 formed on the third film layer 114. The embossing resin layer 112 comprises an areal weight of 0.023 lb/ft² to 0.031 lb/ft². The third film layer 114 comprises a very thin polyvinyl fluoride film, such as Tedlar® PVF film, having a thickness of around two mils. The adhesive layer 116 is heat activated and “strippable”, meaning that it allows the laminate panel 100 to be easily and quickly removed by the application of heat from a heat gun. A suitable adhesive for this purpose is SPA 110-.4, available from Bostik-Findley, Inc., of Huntington Valley, Pa. The adhesive layer 116 can be temporarily covered, before the laminate panel 100 is applied, by a thin, removable release layer of plastic or other material. Then, once the release layer is removed, the laminate panel 100 is positioned over a desired surface 102 and carefully laid onto the surface 102. Pressure with a roller or other implement can be used to smooth out the laminate panel 100 and to remove air pockets. Alternatively, an exposed surface 114a of the third film layer 114 could be left dry (i.e., no adhesive applied thereto), and at the time the laminate panel 100 is to be installed on the surface 102, a suitable spray adhesive could be sprayed onto the exposed surface 114a of the third film layer 114, or possibly directly onto the surface 102.

Stripping an installed laminate panel 100 from its associated surface 102 is accomplished simply by heating the laminate panel 100 with a heat gun or other like implement (not shown). Once heated sufficiently, the laminate panel 100 is peeled off of its surface 102. Typically, there will be little or no residue left behind on the surface 102. Any residual adhesive that is be left can be easily and quickly cleaned with a mild cleaning detergent, or possibly soapy water. The surface 102 is then ready to receive a new laminate panel comprising a segment of or an entire image 19.

With continuing reference to FIGS. 3 and 4, and additional reference to FIG. 5, an alternative laminate panel 200, similar to laminate panel 10, is applied to the surface 12 to provide the surface 12 with increased thermal resistance. As the laminate panel 200 is similar to the laminate panel 10, the same reference numerals will be used herein to denote the same or similar components. The laminate panel 200 includes the first film layer 16 having a texture on its outer surface 16a. The first film layer 16 comprises a very thin polyvinyl fluoride film, such as Tedlar® PVF film, having a thickness of about one mil. The first film layer 16 is also a clear gloss or a semi-gloss layer, but in either event it is substantially translucent or clear. Adjacent to the first film layer 16 can be an ink layer 18a.

Ink layer 18a represents the ink that comprises the image 19; however, it will be understood that the laminate panel 200 could be formed without the ink layer 18a, if so desired. The ink layer 18a is formed on an inside surface 16b of the first film layer 16. This eliminates the need to place a protective, separate layer over the ink layer 18a, since the first film layer 16, itself, forms a protective covering for the ink on its inside surface 16b.

If the ink layer 18a is desired, it is deposited by a suitable printer, such as a digital ink jet printer, directly on the first film layer 16. The ink used to form ink layer 18a, which makes up the image 19, comprises an ultraviolet (UV) curable and stable ink (black or colored) that is deposited directly on the first film layer 16. Since the ink layer 18a is deposited on the inside surface 16b, it will be appreciated that the image 19 will need to be transposed during the printing process so that it appears correct when being viewed from the opposite side (i.e., outer surface 16a) of the first film layer 16. Alternatively, the ink layer 18a could be formed on a second film layer 202, as discussed previously herein. The second film layer 202 is generally disposed against the inside surface 16b of the first film layer 16.

The second film layer 202 comprises a polyvinyl fluoride (PVF) layer that is impregnated with aluminum oxide trihydrate, or aluminum trihydrate (ATH). The optimal loading level for ATH typically falls between 30% and 60%, but can range from 20% to 80% by weight. The addition of ATH to the PVF to form second film layer 202 serves to increase the fire worthiness of the second film layer 202 while imparting opacity to the second film layer 202. ATH is a pigment that contains three moles of water molecules for every mole of aluminum oxide. During combustion, the water molecules will be converted from a liquid phase to a gas phase, and this conversion requires a significant amount of thermal energy, approximately 970 British thermal units per pound water (BTU/lb. water). Thus, ATH acts as a heat sink, absorbing a significant amount of thermal energy to decrease the amount of heat released by the surface 12 during a combustion event, thereby improving the fire worthiness of the laminate panel 200.

The second film layer 202 forms a suitable background against which the colors of the ink layer 18a stand out, such as a white background. However, it will be appreciated that other colors could be utilized depending on the color scheme used in the image 19. It should be noted that since ATH has a different index of refraction than that of the titanium dioxide, which comprises the first film layer 16, the same ink formulation likely will not be useable on either the first film layer 16 or the second film layer 202. Although the ink layer 18a likely should have a different formulation, the reformulated ink layer 18a, as shown in FIG. 5, can be composed of a UV curable ink with similar properties and characteristics as the UV curable ink that forms the ink layer 18. The reformulated ink layer 18a can be disposed directly onto the second film layer 202 and cured, as described previously herein.

The laminate panel 200 further includes the layer 24 comprised of an embossing resin, and a third film layer 204 that is comprised of PVF impregnated with ATH. The layer of embossing resin 24 can vary significantly in thickness, but in one form comprises an areal weight of about 0.023 pounds per square feet (lb/ft²) to 0.031 lb/ft². The third film layer 204 is disposed against the surface 12. The third film layer 204 has a thickness of around two mils and is generally opaque in color, such as white.

The laminate panel 200 is formed using the same process employed to form laminate panel 10. Specifically, the laminate panel 200 is placed in a conventional multi-opening press, which uses heat and pressure to laminate the individual layers making up laminate panel 200 together as a single, decorative, textured laminate structure. The textured outer surface 16a of the first film layer 16 is maintained by the embossing resin of layer 24 as the resin cures in the multi-opening press during manufacture. The decorative textured laminate panel 200 is then secured to the desired surface 12 through various techniques, such as the use of a spray adhesive applied to the surface 12 or through the use of an IR oven to form the laminate panel 200 on to the surface 12, as discussed previously. Some trimming of excess material or edge wrapping of laminate panel 200 can be required to achieve maximum aesthetic appeal.

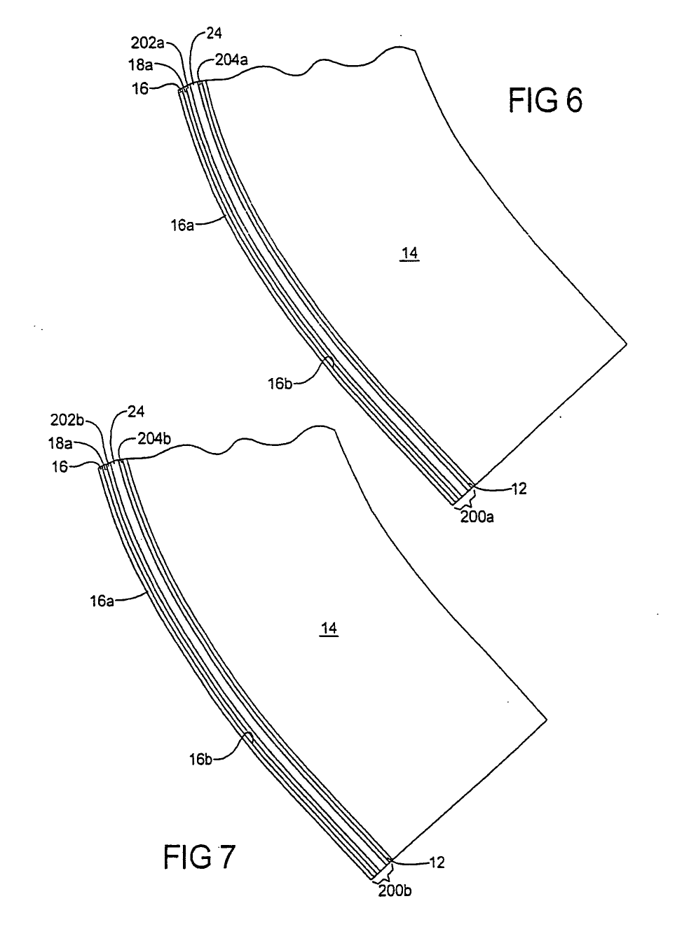

With continuing reference to FIGS. 3, 4 and 5, and with additional reference to FIG. 6, a second alternative composition of the laminate panel 200 is shown. As only the composition of the second film layer 202 and third film layer 204 have been altered, only these features will be discussed. In particular, a second alternative laminate panel 200a is shown to include a second film layer 202a and a third film layer 204a. The second film layer 202a and third film layer 204a each comprise fluorinated ethylene-propylene (FEP) impregnated with ATH. The optimal loading level for ATH typically falls between 30% and 60%, but can range from 20% to 80% by weight. Similar to the laminate panel 200, the ink layer 18a is applied to the second film layer 202a, but the ink employed to create the ink layer 18a may have to be reformulated due to the difference in the index of refraction of the second film layer 202a and second film layer 202. Both the second film layer 202a and third film layer 204a are also generally opaque and typically are white. The third film layer 204a is disposed against the surface 12.

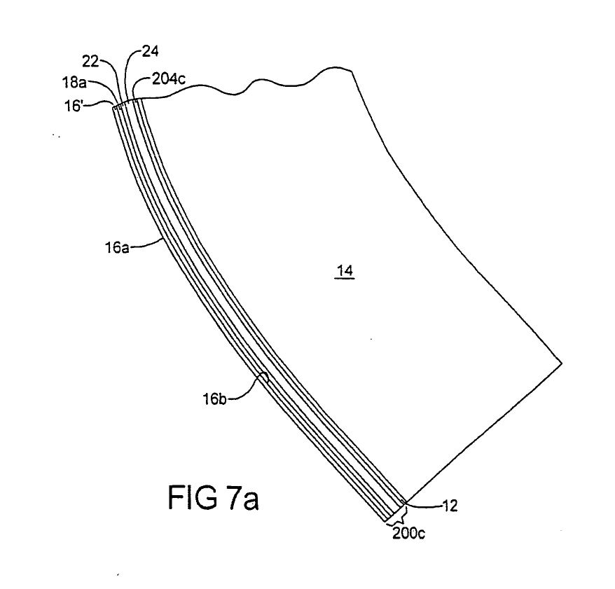

With additional reference to FIG. 7, a third alternative composition of the alterative laminate panel 200 is illustrated. In this embodiment, a third alternative laminate panel 200b includes a second film layer 202b and a third film layer 204b. As only the compositions of the second film layer 202 and third film layer 204 have been altered in this embodiment, only these features will be discussed. The second film layer 202b and third film layer 204b each comprises a silicone type polymer including an alkyl group, such as a methyl or ethyl group, impregnated with ATH. (Dow Corning 0-3016 is one suitable polymer that could be employed.) The optimal loading level for ATH typically falls between 30% and 60%, but can range from 20% to 80% by weight. Similar to the laminate panel 200, the ink layer 18a is applied to the second film layer 202b, but the ink employed to create the ink layer 18a may have to be reformulated due to the difference in the index of refraction of the second film layer 202b and second film layer 202. Both the second film layer 202b and third film layer 204b are also generally opaque and typically are white. The third film layer 204b is disposed against the surface 12.

Alternatively, as shown in FIG. 7a, a fourth alternative composition of the alternative laminate panel 200 is illustrated. As only the compositions of the first film layer 16 and third film layer 204 have been altered in this embodiment, only these features will be discussed. In this embodiment, a fourth alternative laminate panel 200c is shown with a first film layer 16′. The first film layer 16′ can comprise PVF impregnated with ATH, FEP impregnated with ATH or a silicone type polymer including an alkyl group and impregnated with ATH to further improve the fire worthiness of the laminate panel 200c. The optimal loading level for ATH typically falls between 30% and 60%, but can range from 20% to 80% by weight. The second film layer 22 is disposed adjacent to the first film layer 16′ and comprises PVF. Similar to laminate panel 200, the ink layer 18a is applied to the second film layer 22, but the ink employed to create the ink layer 18a may have to be reformulated due to the difference in the index of refraction of the first film layer 16′. The embossing resin layer 24 is disposed between the second film layer 22 and a third film layer 204c. The third film layer 204c comprises PVF impregnated with ATH, FEP impregnated with ATH or silicone type polymer including an alkyl group and impregnated with ATH. The optimal loading level for ATH typically falls between 30% and 60%, but can range from 20% to 80% by weight. Both the first film layer 16′ and third film layer 204c are also generally opaque and typically are white. The third film layer 204c is disposed against the surface 12.

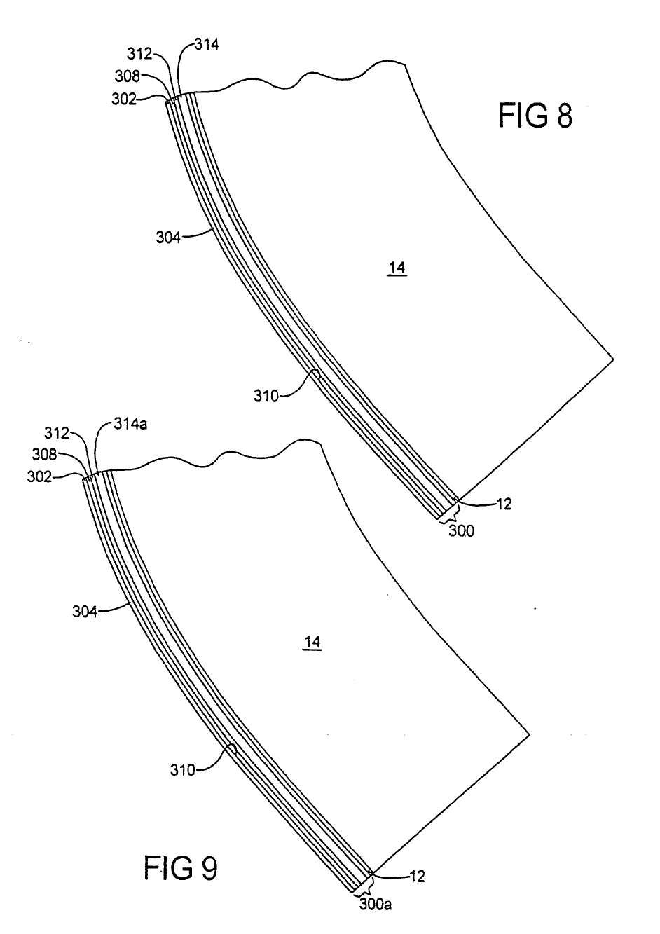

With continuing reference to FIG. 8, a fifth alternative composition of a fixed laminate panel is provided. The laminate panel 300, similar to laminate panel 200, is shown. In this embodiment, the laminate panel 300 includes a first film layer 302 having a first side 304 that forms the outside surface of the laminate panel 300. The first film layer 302 is generally comprised of a substantially transparent polyvinyl fluoride film, such as a Tedlar® PVF film, having a thickness of approximately one mil. Adjacent to the first film layer 302 can be an ink layer 308. The ink layer 308 forms the image 19 on the laminate panel 300; however, the ink layer 308 is optional. If included in the formation of the laminate panel 300, then the ink layer 308 is comprised of metallic or pearlescent ink that is screen printed upon a second side 310 of the first film layer 302 by any appropriate screen printing process.

If the ink layer 308 is employed in the formation of the laminate panel 300, then an embossing resin layer 312 is positioned adjacent to the ink layer 308. Otherwise, the embossing resin layer 312 is disposed against the first film layer 302. As the embossing resin layer 312 generally includes a fire retardant (heat sink) material as part of its formulation, it is layered closer to the first film layer 302 of the laminate panel 300 to improve the overall heat resistance of the laminate panel 300. Thus, by placing the embossing resin layer 312 closer to a possible source of flame (i.e., the exterior surface 15 of the laminate panel 300) the embossing resin layer 312 serves to slow the combustion process and reduce the intensity of the combustion event, resulting in a reduced heat release value for the laminate panel 300. The embossing resin layer 312 is also disposed adjacent to a second film layer 314. The second film layer 314 comprises opaque or white thin polyvinyl fluoride film, such as a Tedlar® PVF film, having a thickness of approximately two mils.

The laminate panel 300 is formed using the same process employed to form laminate panel 200. Specifically, the laminate panel 300 is placed in a conventional multi-opening press, which uses heat and pressure to laminate the individual layers making up the laminate panel 300 together as a single textured laminate structure. The textured outside surface of the first film layer 302 is maintained by the embossing resin layer 312 as the resin cures in the multi-opening press during manufacture. The laminate panel 300 is then coupled to the surface 12 via the use of an IR oven, as discussed previously herein.

An alternative composition of the laminate panel 300 is shown in FIG. 9. As only the composition of the second film layer 314 has been altered, only this feature will be discussed. In particular, a sixth alternative laminate panel 300a is shown to include a second film layer 314a. The second film layer 314a comprises tetrafluoroethhylene, hexaflouropropylene and vinylidene fluoride (THV™) to further reduce the heat released by the laminate panel 300a. The use of THV™ film reduces the heat released by the laminate panel 300a because the chemical composition of the THV™ film creates a material with desirable physical properties while providing a high Limiting Oxygen Index (LOI) material. The LOI is a measurement of the minimum percentage of oxygen required to sustain ignition and combustion. Generally, materials with a high LOI, such as an LOI of greater than 30%, are considered to be self-extinguishing polymers.

The second film layer 314a is generally opaque or white, and typically has a thickness of two mils. Similar to the laminate panel 300, the second film layer 314a is disposed adjacent to the embossing resin layer 312, and the alternative laminate panel 300a is formed in substantially the same way as the laminate panel 300.

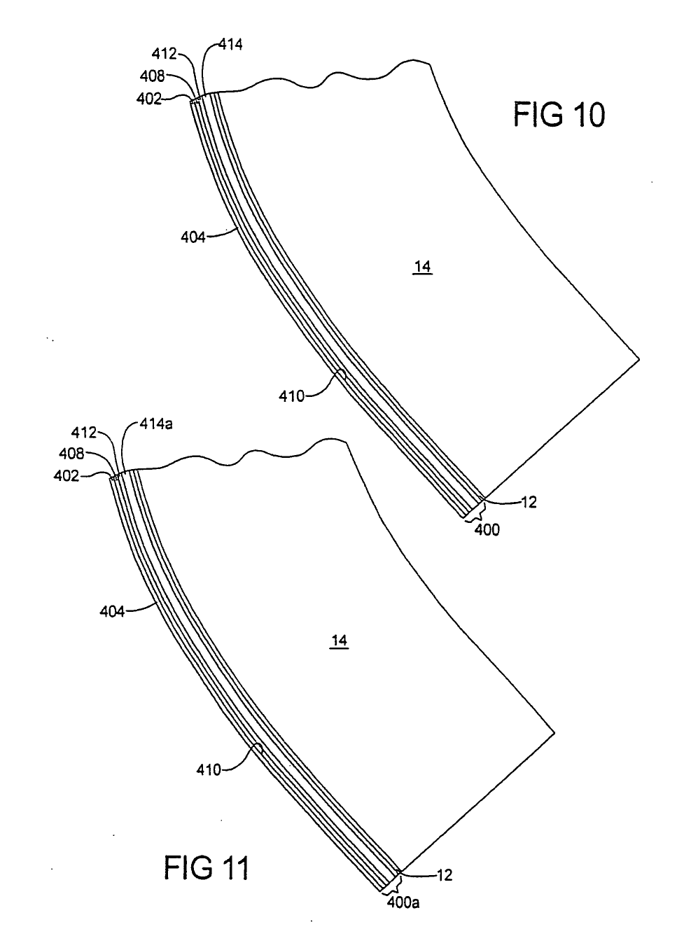

With reference now to FIG. 10, a seventh alternative laminate panel 400 is shown. The laminate panel 400 is similar to laminate panel 300. The laminate panel 400 includes a first film layer 402 having a first side 404 that forms the outside surface of the laminate panel 400. The first film layer 402 is generally comprised of substantially transparent polyvinyl fluoride film, such as a Tedlar® PVF film, having a thickness of approximately one mil and including an ultraviolet (UV) blocker. The first film layer 402 includes a texture to create an aesthetically pleasing exterior surface. Adjacent to the first film layer 402 is an ink layer 408. The ink layer 408 is used to form the image 19 on the laminate panel 400, however, the ink layer 408 is optional. If included in the formation of the laminate panel 400, then the ink layer 408 is comprised of UV cured ink jet ink, which is printed on a second side 410 of the first film layer 402 using any appropriate ink jet printer, as discussed previously herein.

If the ink layer 408 is employed in the formation of the laminate panel 400, then an embossing resin layer 412 is positioned adjacent to the ink layer 408. Otherwise, the embossing resin layer 412 is disposed against the first film layer 402. As the embossing resin layer 412 generally includes a fire retardant (heat sink) material as part of the formulation of the embossing resin, the embossing resin layer 412 is layered closer to the outside surface of the laminate panel 400 to improve the heat resistance of the material, as discussed previously. The embossing resin layer 412 is generally white or opaque in color as the ink jet printing is a subtractive practice that requires an opaque or white background to create the image 19. In addition, the use of the UV blocker in the first film layer 402 further serves to protect an ink jet printed image as without the UV blocker in the first film layer 402, the exposure of the laminate panel 400 to UV light can cause the image to yellow over time.

The embossing resin layer 412 is also disposed adjacent to a second film layer 414. The second film layer 414 generally comprises an opaque or white polyvinyl fluoride film, such as a Tedlar® PVF film, having a thickness of approximately two mils. The laminate panel 400 is formed using the same process employed to form laminate panel 300. Specifically, the laminate panel 400 is placed in a conventional multi-opening press, which uses heat and pressure to laminate the individual layers making up the laminate panel 400 together as a single textured laminate structure. The textured outside surface of the first film layer 402 is maintained by the embossing resin layer 412 as the resin cures in the multi-opening press during manufacture. The laminate panel 400 is then coupled to any appropriate surface 12 through the use of an IR oven, as discussed herein.

An alternative composition of the laminate panel 400 is shown in FIG. 11. As only the composition of the second film layer 414 has been altered, only this feature will be discussed. In particular, an eighth alternative laminate panel 400a is shown to include a second film layer 414a. The second film layer 414a comprises THV™ film to further reduce the heat released by the laminate panel 400a. The second film layer 414a is generally opaque or white and generally has a thickness of two mils. Similar to the laminate panel 400, the second film layer 414a is disposed adjacent to the embossing resin layer 412, and the laminate panel 400a is formed in substantially the same way as the laminate panel 400.

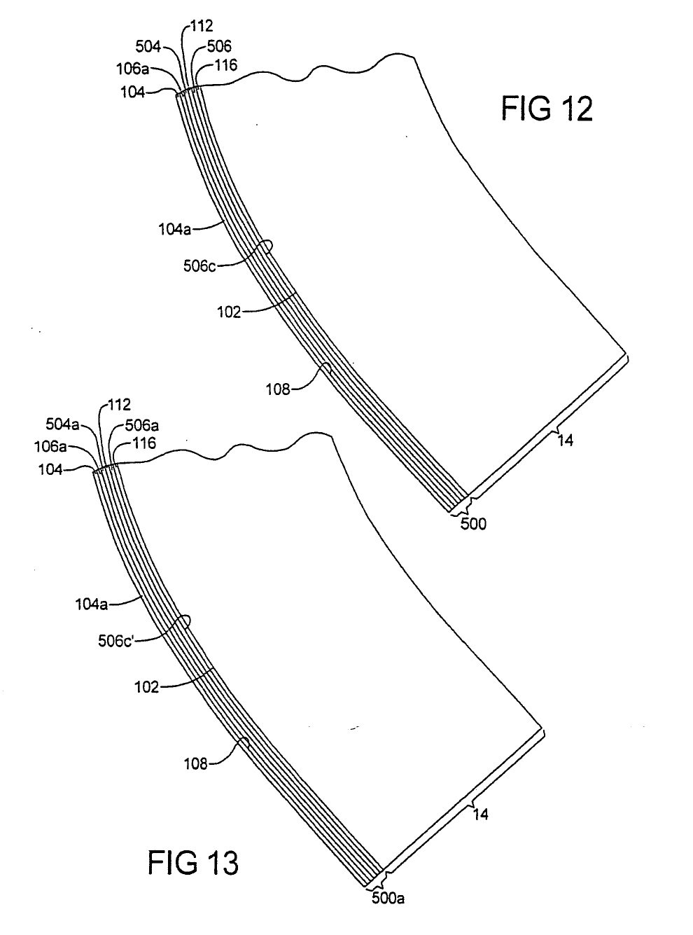

Referring now to FIG. 12, the laminate panel 10 of the alternative embodiment incorporating the second film layer 202 and third film layer 204 is illustrated according to an alternative form of implementation. Specifically, a strippable laminate panel 500 is secured to the surface 102, and as discussed previously, the image 19 is changed simply by removing the bin door 14 from the mobile platform 8 and removing each of the strippable laminate panels 500 from their respective surfaces 102. Then, a new strippable laminate panel having a different image is applied to the surface 102, as discussed previously herein.

As shown in FIG. 12, the laminate panel 500 is similar in construction to laminate panel 100. As such, the same reference numerals used to describe laminate panel 100 will be used to denote the same or similar components. The alternative laminate panel 500 includes the first film layer 104 having a texture on its outer surface. The first film layer 104 comprises a thin polyvinyl fluoride film, such as a Tedlar® PVF film, having a thickness of about one mil. The first film layer 104 is also a clear gloss or a semi-gloss layer, but in either event it is substantially translucent or clear. The ink layer 106a comprises the image 19. The ink layer 106a is formed on an inside surface 108 of the first film layer 104, and thus, a separate, protective layer is not required. The inside surface 108 typically has a very thin adhesive layer left after the backing of the first film layer 104 is removed, and the ink layer 106a is deposited on this adhesive if the ink layer 106a is desired. The ink used to form ink layer 106a comprises an ultraviolet (UV) curable and stable ink (black or colored).

A second film layer 504 is disposed against the inside surface 108 of first film layer 104, and thus against the ink layer 106a. The second film layer 504 is comprised of PVF impregnated with ATH, with the amount of ATH as necessary to form a suitable background against which the colors of the ink layer 106a stand out. It should be noted that, alteratively, the ink layer 106a could be formed on the second film layer 504. In order to form the ink layer 106a on the second film layer 504, the ink used to form the ink layer 106a will likely have to be reformulated, as discussed previously herein.

The decorative textured laminate panel 500 further includes an embossing resin layer 112, a third film layer 506 disposed against the embossing resin layer 112, and an adhesive layer 116 formed on the third film layer 506. The third film layer 506 comprises a polyvinyl fluoride (PVF) material impregnated with aluminum oxide trihydrate, or aluminum trihydrate (ATH). The optimal loading level for ATH typically falls between 30% and 60%, but can range from 20% to 80% by weight. The third film layer 506 generally has a thickness of around two mils. The embossing resin layer 112 also comprises an areal weight of about 0.023 lb/ft² to 0.031 lb/ft². The adhesive layer 116 is heat activated and strippable to enable laminate panel 500 to be easily and quickly removed. The adhesive layer 116 is temporarily covered, before the laminate panel 500 is applied, by a thin, removable release layer of plastic or other material. Then, once the release layer is removed, the laminate panel 500 is positioned over its respective surface 102 and carefully laid onto the surface 102. Pressure with a roller or other implement can be used to smooth out the laminate panel 500 and to remove air pockets.

Alternatively, an exposed surface 506c of the third film layer 506 could be left dry (i.e., no adhesive applied thereto), and at the time the laminate panel 500 is to be installed on the surface 102, a suitable spray adhesive could be sprayed onto the exposed surface 506c of the third film layer 506, or possibly onto the surface 102.

With reference to FIG. 13, a second alternative composition laminate panel 500a is shown. The second alternative composition laminate panel 500a is substantially similar to the laminate panel 500, except the second film layer 504 and a third film layer 506 are comprised of different materials. Thus, only the altered compositions will be discussed. The alternative composition laminate panel 500a includes a second film layer 504a and a third film layer 506a. The second film layer 504a and the third film layer 506a each comprises fluorinated ethylene-propylene (FEP) impregnated with ATH. The optimal loading level for ATH typically falls between 30% and 60%, but can range from 20% to 80% by weight. Similar to the laminate panel 500, the ink layer 106a is applied to the second film layer 504a if desired, but the ink employed to create the ink layer 106a may have to be reformulated due to the difference in the index of refraction of the second film layer 504a and second film layer 504. As discussed previously herein, the ink layer 106a is optional. Third film layer 506a is disposed against the adhesive layer 116, or is left dry in order for a suitable spray adhesive to be sprayed onto the exposed surface 506c′ of the third film layer 506a, or possibly onto the surface 102. Both the second film 504a and third film 506a are also generally opaque and typically are white in color.

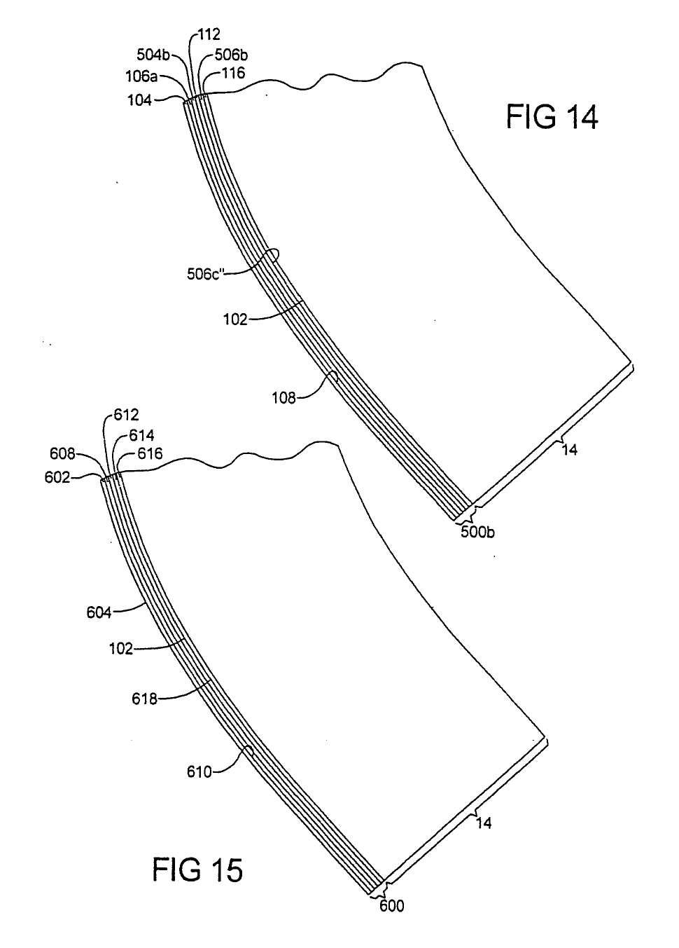

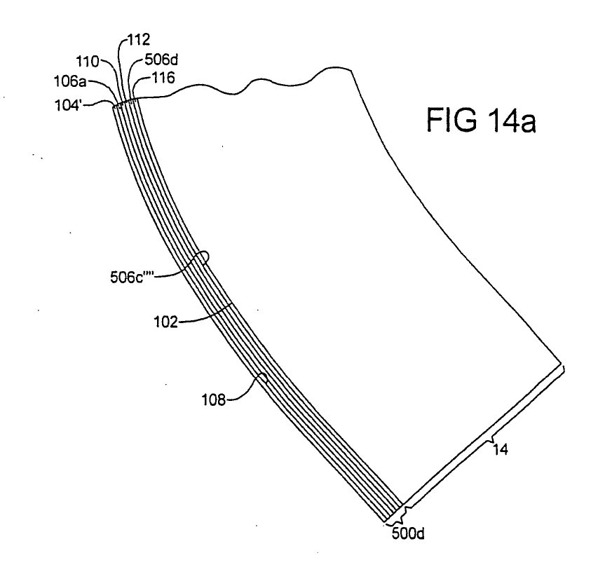

With reference to FIG. 14, a third alternative composition laminate panel 500b is shown. The third alternative composition laminate panel 500b is substantially similar to the laminate panel 500, except the second film layer 504 and third film layer 506 are comprised of different materials, and thus, only the altered compositions will be discussed. The second alternative composition laminate panel 500b includes a second film layer 504b and a third film layer 506b. The second film layer 504b and the third film layer 506b each comprises a silicone type polymer including an alkyl group, such as a methyl or ethyl group, impregnated with ATH. The optimal loading level for ATH typically falls between 30% and 60%, but can range from 20% to 80% by weight. (Dow Corning 0-3016 is a specific polymer that could be employed.) Similar to the laminate panel 500, the ink layer 106a is applied to the second film layer 504b if desired, but the ink employed to create the ink layer 106a may have to be reformulated due to the difference in the index of refraction of the second film layer 504b and second film layer 504. As discussed previously herein, the ink layer 106a is optional. The third film layer 506b is disposed against the adhesive layer 116, or is left dry in order for a suitable spray adhesive to be sprayed onto an exposed surface 506c″ of the third film layer 506b, or possibly onto the surface 102. Both the second film layer 504b and third film layer 506b are also generally opaque and typically are white.

Alternatively, as shown in FIG. 14a, a fourth alternative composition of the alternative laminate panel 500 is illustrated. As only the compositions of the first film layer 104 and third film layer 506 have been altered in this embodiment, only these features will be discussed. In this embodiment, a fourth laminate panel 500d is shown with a first film layer 104′. The first film layer 104′ comprises PVF impregnated with ATH, FEP impregnated with ATH or a silicone type polymer including an alkyl group and impregnated with ATH to further improve the fire worthiness of the laminate panel 500d. The optimal loading level for ATH typically falls between 30% and 60%, but can range from 20% to 80% by weight. The second film layer 110 is disposed adjacent to the first film layer 104′ and comprises PVF. Similar to alternative laminate panel 500, the ink layer 106a is applied to the second film layer 110, if the ink layer 106a is desired; however, the ink employed to create the ink layer 106a may have to be reformulated due to the difference in the index of refraction of the first film layer 104′. The embossing resin layer 112 is disposed between the second film layer 110 and a third film layer 506d. The third film layer 506d comprises PVF impregnated with ATH, FEP impregnated with ATH or silicone type polymer including an alkyl group and impregnated with ATH. The optimal loading level for ATH typically falls between 30% and 60%, but can range from 20% to 80% by weight. The third film layer 506d is disposed against the adhesive layer 116, or is left dry in order for a suitable spray adhesive to be sprayed onto an exposed surface 506c″″ of the third film layer 506d, or possibly onto the surface 102. Both the first film 104 and third film 506d are also generally opaque and typically are white in color.

With additional reference to FIG. 15, another alternative implementation is shown including a fifth alternative composition strippable laminate panel 600. Strippable laminate panel 600 is similar to laminate panel 100, and includes a first film layer 602 having a first side 604 that forms the exterior surface 15 of the laminate panel 600. The first side 604 can be textured if desired (not specifically shown). The first film layer 602 is generally comprised of substantially transparent polyvinyl fluoride film, such as a Tedlar® PVF film, having a thickness of approximately one mil. Adjacent to the first film layer 602 is an ink layer 608. The ink layer 608 is used to form the image 19 on the laminate panel 600; however, the ink layer 608 is optional. If included in the formation of the laminate panel 600, then the ink layer 608 is comprised of metallic or pearlescent ink, which is screen printed upon a second side 610 of the first film layer 602 by any suitable screen printing process.

If the ink layer 608 is employed in the formation of the laminate panel 600, then an embossing resin layer 612 is positioned adjacent to the ink layer 608. Otherwise, the embossing resin layer 612 is disposed against the first film layer 602. As the embossing resin layer 612 generally includes a fire retardant (heat sink) material as part of the formulation of the embossing resin, the embossing resin layer 612 is layered closer to the outside surface of the laminate panel 600 to improve the heat resistance of the material. The embossing resin layer 612 is disposed adjacent to a second film layer 614. The second film layer 614 comprises an opaque or white polyvinyl fluoride film, such as a Tedlar® PVF film, having a thickness of approximately two mils.

An adhesive layer 616 is typically formed on a second side 618 of the second film layer 614. Adhesive layer 616 is heat activated and strippable to allow the laminate panel 600 to be easily and quickly removed. The adhesive layer 616 is temporarily covered, before the laminate panel 600 is applied, by a thin, removable release layer of plastic or other material (not specifically shown). Then, once the release layer is removed, the laminate panel 600 is positioned over the desired application surface and carefully laid onto the surface. Pressure with a roller or other implement can be used to smooth out the laminate panel 600 and to remove air pockets. Alternatively, the second side 618 of the second film layer 614 could be left dry (i.e., no adhesive applied thereto), and at the time the laminate panel 600 is to be installed on the desired surface 102, a suitable spray adhesive could be sprayed onto the second side 618 of the second film layer 614, or possibly onto the desired surface 102.

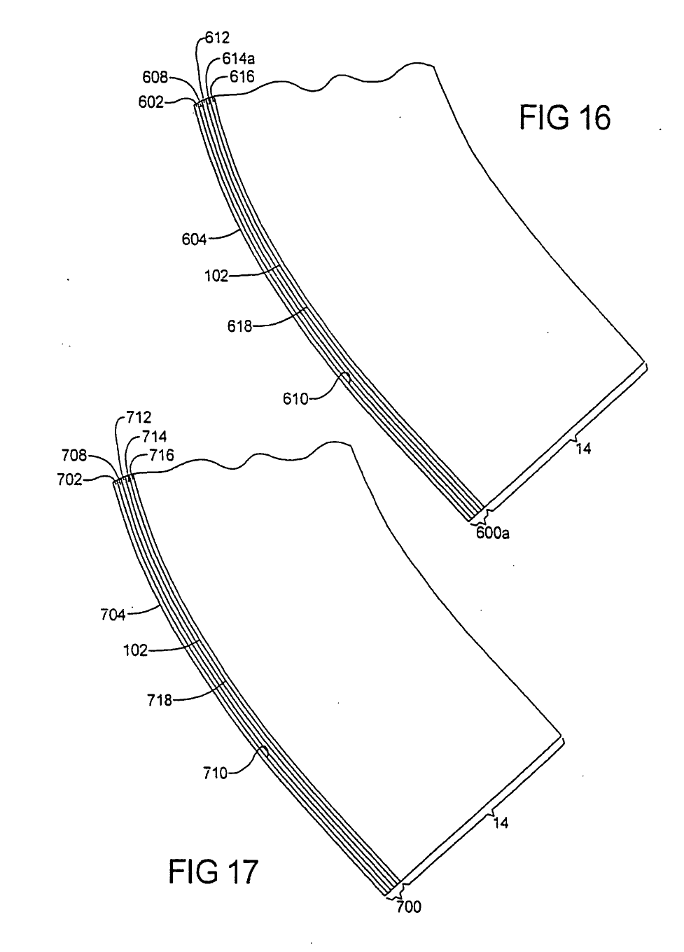

With reference to FIG. 16, a sixth alternative composition laminate panel 600a is shown. The alternative composition laminate panel 600a is substantially similar to the laminate panel 600, except the second film layer 614 is comprised of alternative materials. Thus, only the altered composition of the second film layer 614 will be discussed. In particular, an alternative composition laminate panel 600a is shown to include a second film layer 614a. The second film layer 614a comprises a THV™ film to further reduce the heat released by the alternative composition laminate panel 600a. The second film layer 614a is generally opaque or white, and generally has a thickness of two mils. Similar to the laminate panel 600, the second film layer 614a is disposed adjacent to the embossing resin layer 612, and the alternative composition laminate panel 600a is formed in substantially the same way as the laminate panel 600.

With reference now to FIG. 17, a seventh alternative composition laminate panel 700 is shown. The laminate panel 700 includes a first film layer 702 having a first side 704 that forms an exterior surface 15 of the laminate panel 700. The first film layer 702 is generally comprised of substantially transparent polyvinyl fluoride film, such as a Tedlar® PVF film, having a thickness of approximately one mil and including an ultraviolet (UV) blocker. Adjacent to the first film layer 702 is an ink layer 708. The ink layer 708 is used to form the image 19 on the laminate panel 700; however, the ink layer 708 is optional. If included in the formation of the laminate panel 700, then the ink layer 708 is comprised of UV cured ink jet ink, which is printed on a second side 710 of the first film layer 702 by any suitable ink jet printer, as previously described herein. The use of the UV blocker in the first film layer 702 serves to protect the ink jet printed image, if included, from fading or yellowing due to UV rays.

If the ink layer 708 is employed in the formation of the laminate panel 700, then an embossing resin layer 712 is disposed adjacent to the ink layer 708. Otherwise, the embossing resin layer 712 is disposed against the first film layer 702. As the embossing resin layer 712 generally includes a fire retardant material as part of the formulation of the embossing resin, the embossing resin layer 712 is layered closer to the exterior surface 15 of the laminate panel 700. The embossing resin layer 712 is white or opaque in color. The embossing resin layer 712 is disposed adjacent to a second film layer 714. The second film layer 714 comprises opaque or white polyvinyl fluoride film, such as a Tedlar® PVF film, with a thickness of approximately two mils. An adhesive layer 716 is typically formed on a second side 718 of the second film layer 714.

The adhesive layer 716 is heat activated and strippable. The adhesive layer 716 is temporarily covered, before the laminate panel 700 is applied, by a thin, removable release layer of plastic or other material (not specifically shown). Then, once the release layer is removed, the laminate panel 700 is positioned over the desired application surface 102 and carefully laid onto the surface 102. Pressure with a roller or other implement can be used to smooth out the laminate panel 700 and to remove air pockets. Alternatively, the second side 718 of the second film layer 714 could be left dry (i.e., no adhesive applied thereto), and at the time the laminate panel 700 is to be installed on the desired surface 102, a suitable spray adhesive could be sprayed onto the second side 718 of the second film layer 714, or possibly onto the desired surface 102.

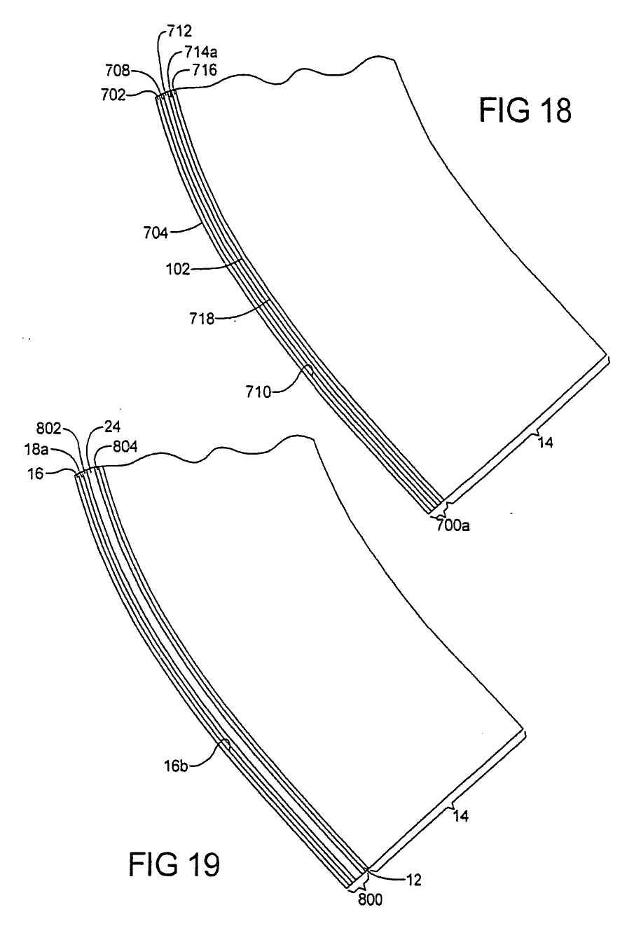

With reference to FIG. 18, an eighth alternative composition laminate panel 700a is shown. The eighth alternative composition laminate panel 700a is substantially similar to the laminate panel 700, except the second film layer 714 is comprised of different materials. Thus, only the altered composition of the second film layer 714 will be discussed. In particular, the alternative composition laminate panel 700a includes a second film layer 714a. The second film layer 714a comprises THV™ to further reduce the heat released by the alternative composition laminate panel 700a. The second film layer 714a is generally opaque or white, and generally has a thickness of two mils. Similar to the laminate panel 700, the second film layer 714a is disposed adjacent to the embossing resin layer 712, and the alternative composition laminate panel 700a is formed in substantially the same way as the laminate panel 700.

The use of the first film layers 16′, 104′, second film layers 202, 202a, 202b, 504, 504a, 504b and third film layers 204, 204a, 204b, 506, 506a, 506b, 506d require the reformulation of the ink used to create the ink layer 18, 18a, 106, 106a due to the difference in the index of refraction of the ATH. Alternatively, as shown in FIG. 19, a laminate panel 800 is formed using a second film layer 802 comprised of a polyvinyl fluoride film, such as Tedlar® PVF, and a third film layer 804. As the laminate panel 800 is of similar construction to the laminate panel 10, the same reference numerals will be used to denote the same or similar components. The laminate panel 800 includes the first film layer 16. The first film layer 16 is composed of a polyvinyl fluoride film, such as a Tedlar® PVF film, having a thickness of about one mil. The first film layer 16 is also a clear gloss or a semi-gloss layer, but in either event it is substantially translucent or clear. The ink layer 18a is formed on an inside surface 16b of the first film layer 16 to comprise the image 19 or the ink layer 18 could be formed on a second film layer 802, which would also eliminate the need to transpose the image during the printing process. It should be noted that the ink layer 18 is optional. The second film layer 802 is disposed against the inside surface 16b of first film layer 16.

The laminate panel 800 further includes the layer 24 comprised of an embossing resin and a third film layer 804. The layer of embossing resin 24 can vary significantly, but in one form comprises an areal weight of 0.023 pounds per square feet (lb/ft²) to 0.031 lb/ft². The third film layer 804 is comprised of polyvinyl fluoride impregnated with ATH, similar to third film layer 204. Alternatively, the third film layer 804 can be the third film layer 204a, which is composed of FEP impregnated with ATH, or the third film layer 204b, which is composed of silicone alkyl based polymer impregnated with ATH. The third film layer 804 is disposed against the surface 102. The third film layer 804 also has a thickness of around two mils and is generally opaque in color, and typically is white. The laminate panel 800 is formed using the same process employed to form laminate panel 10, as discussed previously. As the laminate panel 800 includes only one film layer that is impregnated with ATH, the ink comprising the ink layer 18 may not have to be reformulated to present the same image as would be found in laminate panel 10.

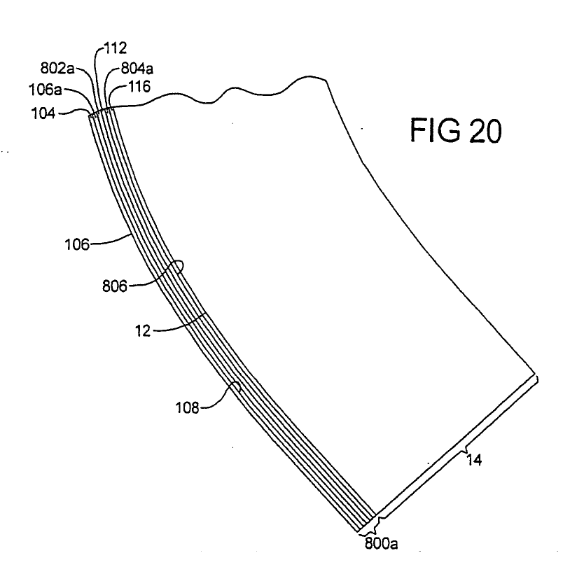

Alternatively, the laminate panel 800 can be formed as a strippable laminate panel 800a, similar to strippable laminate panel 100. As the laminate panel 800a is similar to the laminate panel 100, the same reference numerals will be used to denote the same or similar components. With reference to FIG. 20, the laminate panel 800a includes the first film layer 104 having a texture on its outer surface 104a. The first film layer 104 comprises a thin polyvinyl fluoride film, such as a Tedlar® PVF film, having a thickness of about one mil. The first film layer 104 is also a clear gloss or a semi-gloss layer, but in either event it is substantially translucent or clear. Ink layer 106 represents the ink layer that comprises the image 19. The ink layer 106 is formed on an inside surface 108 of the first film layer 104, and thus, a separate, protective layer is not required. The inside surface 108 typically has a very thin adhesive layer left after the backing of the first film layer 104 is removed, and the ink layer 106 is deposited on this adhesive. The ink used to form ink layer 106 comprises an ultraviolet (UV) curable and stable ink (black or colored). A second film 802a is disposed against the inside surface 108 of first film layer 104.

The second film 802a cam be comprised of a thin polyvinyl fluoride film, such as a Tedlar® PVF film, to form a suitable background against which the colors of the ink layer 106a stand out. Alternatively, the ink layer 106a could be formed on the second film 802a. The decorative textured laminate panel 800a further includes an embossing resin layer 112, a third film layer 804a disposed against the embossing resin layer 112, and an adhesive layer 116 formed on the third film layer 804a. The embossing resin layer 112 also comprises an areal weight of 0.023 lb/ft² to 0.031 lb/ft². The third film layer 804a is comprised of PVF impregnated with ATH, similar to third film layer 506. Alternatively, the third film layer 804a can be the third film layer 506a, which is composed of FEP impregnated with ATH, or the third film layer 506b, which is composed of silicone alkyl based polymer impregnated with ATH. The third film layer 804 generally has a thickness of around two mils.

The adhesive layer 116 is strippable to allow the laminate panel 800a to be easily and quickly removed. The adhesive layer 116 is temporarily covered, before the laminate panel 800a is applied, by a thin, removable release layer of plastic or other material. Then, once the release layer is removed, the laminate panel 800a is positioned over its respective bin door 14 and carefully laid onto the surface 12 of the bin door 14. Pressure with a roller or other implement can be used to smooth out the laminate panel 800a and to remove air pockets. Alternatively, the exposed surface 804c of the third film layer 804a could be left dry (i.e., no adhesive applied thereto), and at the time the laminate panel 800a is to be installed on the bin door 14, a suitable spray adhesive could be sprayed onto the exposed surface 804c of the third film layer 804, or possibly onto the surface 102 itself, as discussed previously with regard to laminate panel 100.

The incorporation of ATH in the first film layer 16′, 104′, second film layer 202, 202a, 202b, 504, 504a, 504b and third film layer 204, 204a, 204b, 506, 506a, 506b, 506d, 804, 804a serves to increase the fire worthiness of the surface 12, 102 as ATH acts to absorb heat during a combustion event, thus reducing the overall heat released by the surface 12, 102 during combustion. Alternatively, the ATH incorporated in the first film layer 16′, 104′, second film layer 202, 202a, 202b, 504, 504a, 504b and third film layer 204, 204a, 204b, 506, 506a, 506b, 506d would be nano ATH. Nano ATH is aluminum oxide trihydrate that has been fashioned into long tubes or small particles at the nanometer level, and is about one-third the size of standard bulk ATH. As the particle size of nano-ATH is smaller than visible light waves, it will not impact the transparency of the first film layer 16, 16′, 104, 104′ the second film layer 202, 202a, 202b, 504, 504a, 504b or third film layer 204, 204a, 204b, 506, 506a, 506b, 506d if incorporated. Thus, nano-ATH is one type of endothermic pigment that is incorporated into transparent materials without impacting the transparency of the first film layer 16, 16′, 104, 104′ the second film layer 202, 202a, 202b, 504, 504a, 504b or third film layer 204, 204a, 204b, 506, 506a, 506b, 506d and thus the ink layer 18, 106, will not require reformulation.

Alternatively, instead of ATH, the second film layer 202, 202a, 202b, 504, 504a, 504b and third film layer 204, 204a, 204b, 506, 506a, 506b may comprise sodium borate tetrahydrate. Care must be taken, however, as sodium borate cannot always be used interchangeably with ATH because it requires lower processing temperatures to avoid the evolution of water, which occurs at temperatures above 250° F. Loading levels for sodium borate are also lower than those of ATH due to the ten moles of water that are within each mole of crystalline sodium borate tetrahydrate. Typically the loading level will fall between 15% and 30% by weight, but can range from 5% to 55% by weight.

The apparatus and method of the present disclosure thus provides improved fire worthiness for any surface 12, 102 to which the laminate panel 10, 100, 200, 200a, 200b, 200c, 300, 300a, 400, 400a, 500, 500a, 500b, 500d, 600, 600a, 700, 700a, 800, 800a is applied. In addition, the present disclosure enables images, advertising murals or messages to be implemented on various surfaces via ink jet printing, or digital ink jet printing. The images form an aesthetically pleasing appearance and add to the ambience within the passenger cabin area of a mobile platform. It will also be appreciated that while the stowage bin doors form a particularly convenient surface for presenting the image 19, other interior surfaces, such as a ceiling area, could just as readily be employed for the purpose of presenting the image 19. Such an area would be more suitable for presenting an image that is not intended to be changed frequently, whereas the stowage bin doors are ideally suited for images that will be changed periodically.

While various embodiments have been described, those skilled in the art will recognize modifications or variations that might be made without departing from the inventive concept. The examples illustrate the disclosure and are not intended to limit it. Therefore, the description and claims should be interpreted liberally with only such limitation as is necessary in view of the pertinent prior art.

What is claimed is:

1. A laminate panel for forming an aesthetically pleasing fire worthy exterior surface on an object comprising:
a first film layer that forms an exterior surface of the object;
an embossing resin layer disposed adjacent to the first film layer; and
a second film layer disposed adjacent to the embossing resin layer,
the second film layer being impregnated with a heat sink material.

2. The laminate panel of claim 1, wherein the laminate panel further comprises:
an ink layer forming at least a portion of an image, the ink layer disposed adjacent to the first film layer, to be protected by the first film layer.

3. The laminate panel of claim 2, wherein the laminate panel further comprises:
a third film layer disposed between the ink layer and the embossing resin layer,
the third film layer being impregnated with the heat sink material.

4. The laminate panel of claim 3, wherein the ink layer is disposed on a surface of the third film layer or the first film layer so as to be sandwiched between the third film layer and the first film layer.

5. The laminate panel of claim 1, wherein the laminate panel further comprises:
a strippable adhesive layer.

6. The laminate panel of claim 3, wherein the heat sink material used in the third film layer and the second film layer is comprised of a material selected from the group comprising aluminum oxide trihydrate (ATH) and sodium borate.

7. The laminate panel of claim 3, wherein
the first film layer is comprised of a polyvinyl fluoride (PVF); and
the third film layer is comprised of a material selected from the group comprising PVF, silicon polymer and fluorinated ethylene-propylene (FEP).

8. The laminate panel of claim 1, wherein the second film layer is comprised of a material selected from the group comprising PVF, silicon polymer, and FEP.

9. A laminate panel adapted for use in connection with a plurality of functional panels on a mobile platform for displaying an image and improving the fire worthiness of the functional panels, the laminate panel comprising:
a first film layer that forms an exterior surface of the functional panels;
an ink layer forming at least a portion of the image, the ink layer disposed adjacent to the first film layer;
a second film layer disposed adjacent to the ink layer;
an embossing resin layer disposed adjacent to the second film layer; and
the second film layer being impregnated with a heat sink material to improve the fire worthiness of the functional panels.

10. The laminate panel of claim 9, wherein the laminate panel further comprises:
a third film layer disposed adjacent to the embossing resin layer and an exterior surface of the functional panels,
the third film layer being impregnated with the heat sink material.

11. The laminate panel of claim 10, wherein the ink layer is disposed on a surface of the second film layer or the first film layer so as to be sandwiched between the second film layer and the first film layer.

12. The laminate panel of claim 9, wherein the laminate panel further comprises:
a strippable adhesive layer.

13. The laminate panel of claim 10, wherein the heat sink material used in the third film layer and the second film layer is comprised of a material selected from the group comprising: aluminum oxide trihydrate (ATH) and sodium borate.

14. The laminate panel of claim 10, wherein:
the first film layer is comprised of a polyvinyl fluoride (PVF); and
the third film layer is comprised of a material selected from the group comprising PVF, silicon polymer and fluorinated ethylene-propylene (FEP).

15. The laminate panel of claim 9, wherein the second film layer is comprised of a material selected from the group comprising PVF, silicon polymer and FEP.

16. A laminate panel adapted for use in connection with a plurality of functional panels on a mobile platform for displaying an image and improving the fire worthiness of the functional panels, the laminate panel comprising:
a first film layer that forms an exterior surface of the functional panels;
an ink layer forming at least a portion of the image, the ink layer disposed adjacent to the first film layer;
a second film layer disposed adjacent to the ink layer; and
a third film layer disposed adjacent to the second film layer and an exterior surface of the functional panels,
at least one of the second film layer and third film layer being impregnated with a heat sink material to improve the fire worthiness of the functional panels.

17. The laminate panel of claim 16, wherein the laminate panel further comprises:
an embossing resin layer disposed adjacent to the second film layer and the third film layer so as to be sandwiched between the second film layer and third film layer.

18. The laminate panel of claim 16, wherein the laminate panel further comprises:
a strippable adhesive layer.

19. The laminate panel of claim 16, wherein the heat sink material used in the third film layer and the second film layer is comprised of a material selected from the group comprising: aluminum oxide trihydrate (ATH) and sodium borate.

20. The laminate panel of claim 16, wherein:
the first film layer is comprised of a polyvinyl fluoride (PVF);
the second film layer is comprised of a material selected from the group comprising PVF, silicon polymer and fluorinated ethylene-propylene (FEP)
the third film layer is comprised of a material selected from the group comprising PVF, silicon polymer and FEP.
